(19) United States
(12) Patent Application Publication
(10) Pub. No.: US 2020/0126411 A1
(43) Pub. Date: Apr. 23, 2020

(54) CONTROL DEVICE AND TRAFFIC LIGHT SYSTEM

(71) Applicants: LITE-ON ELECTRONICS (GUANGZHOU) LIMITED, Guangzhou (CN); Lite-On Technology Corporation, Taipei (TW)

(72) Inventors: Kun-Zheng Lin, Taipei (TW); Swee-Khim Tan, Taipei (TW)

(73) Assignees: LITE-ON ELECTRONICS (GUANGZHOU) LIMITED, Guangzhou (CN); Lite-On Technology Corporation, Taipei (TW)

(21) Appl. No.: 16/215,646

(22) Filed: Dec. 11, 2018

(30) Foreign Application Priority Data
Oct. 22, 2018 (CN) 201811229591.4

(51) Int. Cl. G08G 1/07

(52) U.S. Cl. CPC G08G 1/07

(57) ABSTRACT

A control device configured to receive a control signal to control a plurality of traffic lights is provided. The control device includes a power supply, a switching element, and a controller. The power supply is configured to output a driving current. The switching element is coupled between the power supply and the traffic lights and configured to transmit the driving current to one of the traffic lights according to a switching signal. The controller is coupled to the switching element and configured to receive the control signal and generate the switching signal according to the control signal. A traffic light system including a plurality of traffic lights and the control device is also provided.

### CROSS-REFERENCE TO RELATED APPLICATION

This application claims the priority benefit of China application serial no. 201811229591.4, filed on Oct. 22, 2018. The entirety of the above-mentioned patent application is hereby incorporated by reference herein and made a part of this specification.

### BACKGROUND

### Technical Field

The disclosure relates to a control device and a system, and particularly relates to a control device used for controlling signal lights and a traffic light system.

### Description of Related Art

Traffic lights are usually located at a place where traffic control is required, and are mainly used for presenting signals by using optical color signals that are alternately changed in time, so as to control passing through, stop, turning, etc., of vehicle drivers and pedestrians. Therefore, most of the traffic lights have a plurality of signal lights to provide control information. Moreover, the traffic lights require electric power, which also needs to be used in collaboration with a control command specifying a signal phase.

A commonly used traffic light, for example, a traffic light containing four signal lights, is shown in FIG. 4. The traffic light 1 includes a plurality of signal lights 200R, 200Y, 200G1, 200G2, and a plurality of power supplies PWR, PWY, PWG1, PWG2, where the individual signal lights are independently connected to one power supply, respectively. Control of the traffic light 1 is implemented by using a traffic light controller 20 configured near the traffic light 1 to send a control signal. The control signal generally includes a control signal SR, a control signal SY, a control signal SG1, a control signal SG2 individually corresponding to the signal lights, and the controls signals are respectively input to the power supplies PWR, PWY, PWG1, PWG2 corresponding to the individual signal lights to independently control the on and off of the individual signal lights. However, the volume of such traffic light is excessively large, and it is required to disassemble the whole unit during maintenance, which results in high maintenance cost.

### SUMMARY

The disclosure is directed to a control device and a traffic light system, which have a small volume and are easy for maintenance.

The disclosure provides a control device, which is configured to receive a control signal to control a plurality of signal lights. The control device includes a power supply, a switching element, and a controller. The power supply is configured to output a driving current. The switching component is coupled between the power supply and the signal lights, and is configured to transmit the driving current to one of the signal lights according to a switching signal. The controller is coupled to the switching element, and is configured to receive the control signal and generate the switching signal according to the control signal.

In an embodiment of the disclosure, the controller is further coupled to the power supply, and is configured to generate a current selection signal according to the control signal, where the power supply outputs the driving current according to the current selection signal.

In an embodiment of the disclosure, the power supply includes a current selector, which is configured to determine a magnitude of the driving current according to the current selection signal.

In an embodiment of the disclosure, the controller receives the control signal from at least one of a plurality of channels, and generates the switching signal according to the at least one of the channels receiving the control signal, where each of the channels corresponds to one of the signal lights.

In an embodiment of the disclosure, the controller receives the control signal from a traffic light controller.

The disclosure provides a traffic light system, which functions according to a control signal. The traffic light system includes a plurality of signal lights and a control device. The control device includes a power supply, a switching element, and a controller. The power supply is configured to output a driving current. The switching component is coupled between the power supply and the signal lights, and is configured to transmit the driving current to one of the signal lights according to a switching signal. The controller is coupled to the switching element, and is configured to receive the control signal and generate the switching signal according to the control signal.

In an embodiment of the disclosure, the controller is further coupled to the power supply, and is configured to generate a current selection signal according to the control signal, where the power supply outputs the driving current according to the current selection signal.

In an embodiment of the disclosure, the power supply includes a current selector, which is configured to determine a magnitude of the driving current according to the current selection signal.

In an embodiment of the disclosure, the controller receives the control signal from at least one of a plurality of channels, and generates the switching signal according to the at least one of the channels receiving the control signal, where each of the channels corresponds to one of the signal lights.

In an embodiment of the disclosure, the controller receives the control signal from a traffic light controller.

Based on the above, the control device of the present disclosure, the controller receives the control signal and generates the switching signal according to the control signal, and the switching element turns on/off a circuit corresponding to a specific signal light according to the switching signal, so as to transmit the driving current to one of the signal lights, such that the power supply provides the driving current required for operating the signal lights. In this way, a volume of the control device is reduced, installation of the control device is easier, and maintenance thereof is more convenient.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a traffic light system according to an embodiment of the disclosure.

FIG. 2 is a schematic diagram of a control device according to an embodiment of the disclosure.

FIG. 3 is a schematic diagram of a control device according to another embodiment of the disclosure.

FIG. 4 is a schematic diagram of a traffic light of the prior art.

### DESCRIPTION OF THE EMBODIMENTS

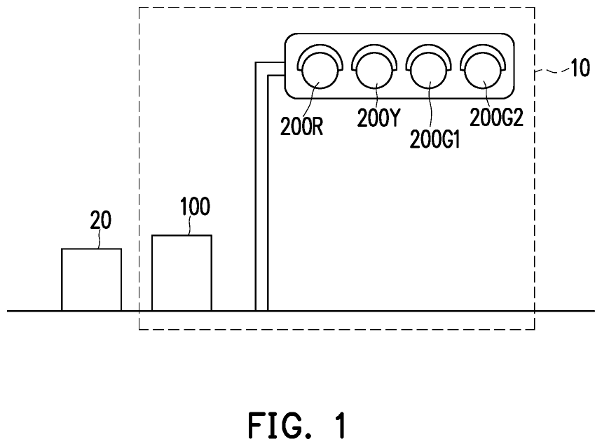

FIG. 1 is a schematic diagram of a traffic light system 10 according to an embodiment of the disclosure. Referring to FIG. 1, the traffic light system 10 of the embodiment includes a plurality of signal lights 200R, 200Y, 200G1, 200G2 and a control device 100. In the traffic light system 10 of the embodiment, the signal lights 200R, 200Y, 200G1, 200G2 are respectively coupled to the control device 100. The control device 100 may control a signal light to emit light according to a control signal. Therefore, the traffic light system 10 of the embodiment may function according to the control signal.

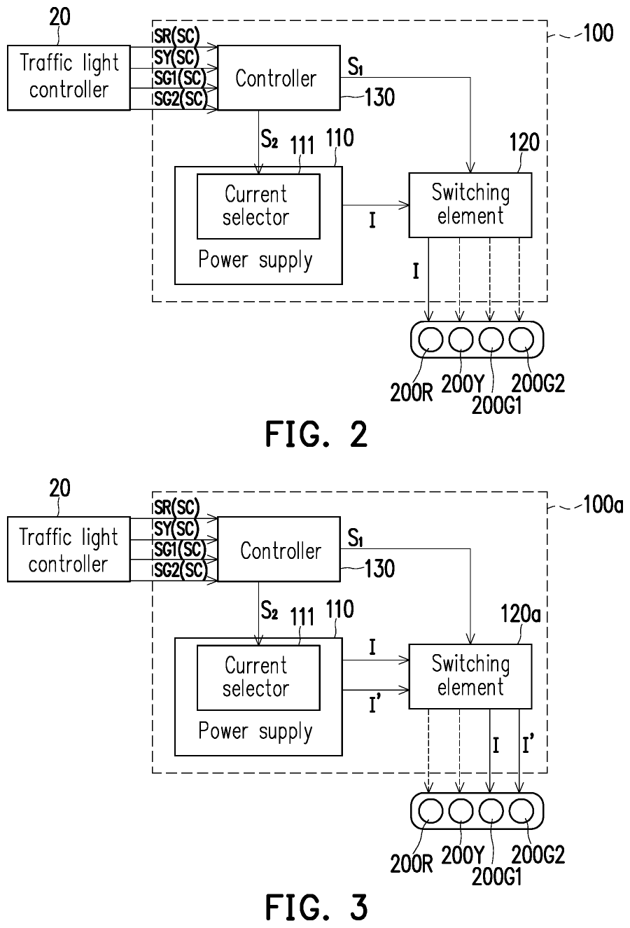

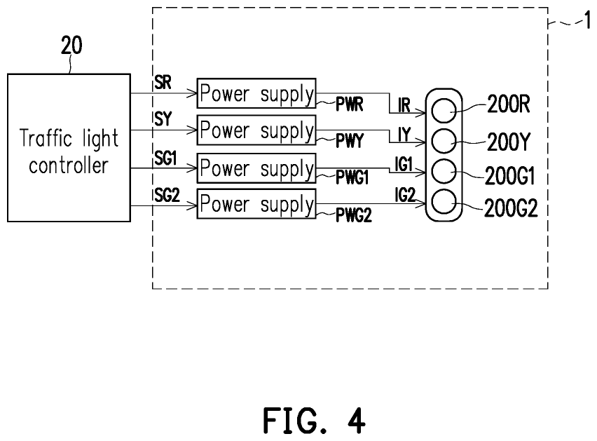

The control device 100 of the embodiment is similar to the control device 100 described in the embodiment of FIG. 2. So that a detailed description of the control device 100 may refer to related description of the embodiment of FIG. 2. The signal lights 200R, 200Y, 200G1, 200G2 of the traffic light system 10 of the embodiment are respectively coupled to a switching element 120 in the control device 100, so that the control device 100 may control the signal light corresponding to the control signal to emit light according to the control signal. Since the control device 100 of the embodiment may provide the driving current required for operating the plurality of signal lights by using only one power supply 110, a volume of the traffic light system 10 may be reduced, so that installation and maintenance of the traffic light system 10 are more convenient.

The traffic light system 10 of the embodiment may also include a light pole, and the signal lights 200R, 200Y, 200G1, 200G2 may be mounted on the light pole. Coupling circuits between the signal lights 200R, 200Y, 200G1, 200G2 and the control device 100 may be disposed in the light poles. It should be noted that in the embodiment, the traffic light system 10 including four signal lights 200R, 200Y, 200G1, 200G2 is taken as an example for description, though in other embodiments, the quantity of the signal lights may be different, and a different color combination of the signal lights may also be configured according to an actual requirement, the disclosure is not limited thereto.

Referring to FIG. 1, in the embodiment, the control device 100 and the plurality of signal lights 200R, 200Y, 200G1, 200G2 may be separately manufactured and separated from each other. The control device 100 may be disposed at periphery of the signal lights 200R, 200Y, 200G1, 200G2, for example, disposed in a control box near the signal lights 200R, 200Y, 200G1, 200G2. However, the disclosure is not limited thereto, and in other embodiments, the control device may also be disposed in internal of the light pole mounted with the traffic lights, or directly hanged on the light pole.

Moreover, in the embodiment, the controller 130 of the traffic light system 10 may receive the control signal from a traffic light controller 20. The traffic light controller 20 is a device disposed on the ground near the signal devices, which is used for controlling operation modes of the signal lights through automatic control or manual control, so as to meet the needs of traffic control, etc., at a road intersection. Generally, the traffic light controller 20 includes main parts such as a central control unit, a color phase control unit, a color phase driving unit, wiring terminals, etc., and generally further includes an input/output unit or a panel control unit to input control instructions or carry out maintenance management. The central control unit, the color phase control unit may include a central processing unit (CPU), a memory accessing device and a clock device. Therefore, the traffic light system 10 of the embodiment may be compatible to the general traffic light controller 20, and may be used in collaboration with the existing devices without replacing or changing the devices of the control system.

In some embodiments, the traffic light controller 20 and the control device 100 may be independently configured and separated from each other, and the traffic light controller 20 may be disposed at a periphery of the control device 100. For example, the traffic light controller 20 may be disposed in the control box near the signal lights together with the control device 100, though the disclosure is not limited thereto.

FIG. 2 is a schematic diagram of a control device 100 according to an embodiment of the disclosure. Referring to FIG. 2, the control device 100 of the embodiment includes a power supply 110, a switching element 120 and a controller 130. The power supply 110 is configured to output a driving current I. The switching element 120 is coupled between the power supply 110 and the signal lights 200R, 200Y, 200G1, 200G2, and is configured to transmit the driving current I coming from the power supply 110 to one of the signal lights 200R, 200Y, 200G1, 200G2 according to a switching signal S1. The controller 130 is coupled to the switching element 120, and is configured to receive a control signal SC and generate the switching signal S1 according to the control signal SC. It should be noted that in the embodiment, the control device 100 controlling the four signal lights 200R, 200Y, 200G1, 200G2 is taken as an example for description, though in other embodiments, the quantity of the signal lights may be different, and a different color combination of the signal lights may also be configured according to an actual requirement, the disclosure is not limited thereto.

For example, in the control device 100 of the embodiment, the controller 130 may receive the control signal SC coming from external of the control device 100, where the control signal SC is, for example, an instruction signal (which, for example, instructs to turn on the red light, yellow light or green light) related with the signal lights 200R, 200Y, 200G1, 200G2. The controller 130 is configured to generate the corresponding switching signal S1 according to the received control signal SC. The switching signal S1 may be transmitted to the switching element 120 based on the coupling relationship between the controller 130 and the switching element 120. When the switching signal S1 is transmitted to the switching element 120, it controls closed and open circuit between electronic contacts of the switching element 120.

The switching element 120 is coupled between the power supply 110 and the signal lights 200R, 200Y, 200G1, 200G2, and by controlling closed and open circuit between the electronic contacts of the switching element 120, electrical connection between the power supply 110 and the individual signal light may be turned on/off, so as to turn on/off the circuit corresponding to the specific signal light. In the embodiment, the power supply 110 provides the driving current I to make the signal light assigned by the control signal SC emit light. In case that the corresponding switching element 120 is turned on, the driving current I output from the power supply 110 may be transmitted to one of the signal lights 200R, 200Y, 200G1, 200G2 through the coupling relationship between the power supply 110, the switching element 120 and the signal lights.

Therefore, when the switching element 120 receives the switching signal S1, the switching element 120 turns on/off the circuit corresponding to the specific signal light, such that the driving current I coming from the power supply 110 may be conducted to the specific signal light through the switching element 120 to make the signal light emit light. Therefore, in the control device 100 of the embodiment, the specific signal light corresponding to the control signal SC may emit light according to the control signal SC, so as to control the signal lights 200R, 200Y, 200G1, 200G2.

It should be noted that in the embodiment, the signal lights 200R, 200Y, 200G1, 200G2 may be coupled to the same power supply 110 through the switching element 120. Moreover, the power supply 110 provides the driving current I required for operating the signal lights 200R, 200Y, 200G1, 200G2. Therefore, in the control device 100 of the embodiment, it is unnecessary to configure one power supply 110 for each of the signal lights 200R, 200Y, 200G1, 200G2, so that the volume of the control device 100 is reduced, installation of the control device 100 is more easy, and maintenance thereof is more convenient.

Moreover, in some embodiments, the controller 130 may also record the control signal SC or the switching signal S1 and a current selection signal S2 to detect an operation mode and interval time of the signal lights 200R, 200Y, 200G1, 200G2 to carry out computation. Therefore, the control device 100 of the disclosure may further provide, for example, a countdown function, or provide other functions such as system abnormity monitoring, system operation recording, etc., though the disclosure is not limited thereto.

In the control device 100 of the embodiment, the controller 130 may be further coupled to the power supply 110, and is configured to generate the current selection signal S2 according to the control signal SC, where the power supply 110 outputs the driving current I according to the current selection signal S2. Further, the power supply 110 may further include a current selector 111, which is configured to determine a magnitude of the driving current I according to the current selection signal S2.

To be specific, in the embodiment, the controller 130 may be further coupled to the power supply 110, and the controller 130 may be selectively configured to generate a current selection signal S2 according to the control signal SC. Therefore, when the controller 130 receives the control signal SC, the controller 130 may generate the corresponding current selection signal S2, and the current selection signal S2 may be transmitted to the power supply 110 through a coupling circuit between the controller 130 and the power supply 110 or other wireless transmission method, such that the power supply 110 may provide the driving current I of a corresponding value according to an instruction of the current selection signal S2. Moreover, the power supply 110 may further include a current selector 111. The power supply 110 receives the current selection signal S2 through the current selector 111, and the current selector 111 adjusts a magnitude of the driving current I according to the current selection signal S2. Therefore, the power supply 110 may provide the driving current I required for operating the individual signal lights 200R, 200Y, 200G1, 200G2 according to specification requirements of the individual signal lights 200R, 200Y, 200G1, 200G2.

It should be noted that in other embodiments, the power supply 110 may also adjust the magnitude of the driving current I through other method. Moreover, adjustment of the driving current I is intended to meet the specification requirements of the individual signal lights 200R, 200Y, 200G1, 200G2, so that in some embodiments, it is unnecessary to adjust the magnitude of the driving current I.

Moreover, in the embodiment, the controller 130 of the control device 100 may receive the control signal SC from the traffic light controller 20. The traffic light controller 20 is a device disposed on the ground near the signal devices, which is used for controlling operation modes of the signal lights through automatic control or manual control, so as to meet the needs of traffic control, etc., at a road intersection. Generally, the traffic light controller 20 includes main parts such as a central control unit, a color phase control unit, a color phase driving unit, wiring terminals, etc., and generally further includes an input/output unit or a panel control unit to input control instructions or carry out maintenance management. The central control unit, the color phase control unit may include a central processing unit (CPU), a memory accessing device and a clock device. Therefore, the control device 100 of the embodiment may be compatible to the general traffic light controller 20, and may be hanged on the existing devices for usage without replacing or changing the devices of the control system.

In the embodiment, the control device 100 and the signal lights 200R, 200Y, 200G1, 200G2 may be independently manufactured and separated from each other, and the control device 100 may be disposed at periphery of the signal lights 200R, 200Y, 200G1, 200G2. For example, the control device 100 may be disposed in a control box near the signal lights 200R, 200Y, 200G1, 200G2, though the disclosure is not limited thereto. In other embodiments, the control device may also be disposed in internal of the light pole mounted with the traffic lights, or directly hanged on the light pole.

In some embodiments, the traffic light controller 20 and the control device 100 may be independently configured and separated from each other, and the traffic light controller 20 may be disposed at a periphery of the control device 100. For example, the traffic light controller 20 may be disposed in the control box near the signal lights together with the control device 100, though the disclosure is not limited thereto.

Further, in the embodiment, the controller 130 may receive the control signal SC from at least one of a plurality of channels, and generate the switching signal S1 according to the channel receiving the control signal SC, where each of the channels corresponds to one of the signal lights 200R, 200Y, 200G1, 200G2.

For example, in the embodiment, the control device 100 is respectively coupled to the signal light 200R, the signal light 200Y, the signal light 200G1 and the signal light 200G2, so that an input terminal of the controller 130 may be configured to have a first channel, a second channel, a third channel and a fourth channel, and the control signal SC may include a control signal SR, a control signal SY, a control signal SG1, a control signal SG2 individually corresponding to the signal lights 200R, 200Y, 200G1, 200G2, where the control signals SR, SY, SG1, SG2 are correspondingly input to the first channel, the second channel, the third channel and the fourth channel, respectively.

To be more specific, in an operation mode of the embodiment, the control device 100 is instructed by the control signal SC to turn on the red light. Therefore, the controller 130 may receive the control signal SR through the first channel, and correspondingly generate the switching signal S1, so that when the switching signal S1 is transmitted to the switching element 120, the switching element 120 turns on the circuit corresponding to the signal light 200R. In this way, the driving current I provided by the power supply 110 could be conducted to the signal light 200R through the switching element 120 to make the signal light 200R to emit light. By similar methods, when the controller 130 receives the control signal SY, SG1 or SG2 through the second, the third or the fourth channel, the controller 130 may also correspondingly generate the switching signal S1 to make the driving current I provided by the power supply 110 be conducted to the signal light 200Y, 200G1 or 200G2 to make the same emit light.

Moreover, according to the control signal SR, SY, SG1 or SG2 coming from different channels, the controller 130 may also generate a current selection signal S2. When the current selection signal S2 is transmitted to the current selector 111 in the power supply 110, the current selector 111 may adjust a magnitude of the driving current I to the driving current I required for operating the signal light 200R, 200Y, 200G1 or 200G2. However, in other embodiments of the disclosure, the controller 130 does not necessarily generate the current selection signal S2.

It should be noted that in other operation modes of the embodiment, different control signals may also be received to make the different signal lights emit light. Moreover, in other embodiments, the controller may also be configured to receive a control signal different from that of the aforementioned modes.

FIG. 3 is a schematic diagram of a control device 100a according to another embodiment of the disclosure. Referring to FIG. 3, the control device 100a of the embodiment is similar to the control device of FIG. 2, and a difference there between is that the switching element 120a of the embodiment may simultaneously turn on the electrical connections of two or more signal lights.

For example, in the embodiment, the control device 100a is respectively coupled to the signal light 200R, the signal light 200Y, the signal light 200G1 and the signal light 200G2, so that the input terminal of the controller 130 may be configured to have a first channel, a second channel, a third channel and a fourth channel, and the control signal SC may include a control signal SR, a control signal SY, a control signal SG1, a control signal SG2 individually corresponding to the signal lights 200R, 200Y, 200G1, 200G2, where the control signals SR, SY, SG1, SG2 are correspondingly input to the first channel, the second channel, the third channel and the fourth channel, respectively.

To be more specific, in an operation mode of the embodiment, the control device 100a is instructed to turn on a first green light (for example, a going-straight green light) and a second green light (for example, a turning-right green light), and the third channel and the fourth channel of the controller 130 may respectively receive the control signals SG1, SG2. The controller 130 may generate a switching signal S1 according to the control signals SG1, SG2, and when the switching signal S1 is transmitted to the switching element 120a, the switching element 120a may simultaneously turn on the circuits corresponding to the signal light 200G1 and the signal light 200G2 to make the same emit light.

In the embodiment, the power supply 110 further has a plurality of output terminals, which are respectively coupled to corresponding terminals of the switching element 120a to respectively provide driving current I, I′ for the signal light 200G1 and the signal light 200G2 to make the signal light 200G1 and the signal light 200G2 emit light.

Moreover, the controller 130 may also generate the current selection signal S2 according the control signals SR, SY, SG1 and SG2. When the current selection signal S2 is transmitted to the current selector 111 in the power supply 110, the current selector 111 may adjust magnitudes of the driving currents I, I′ from the individual output terminals to the driving currents I, I′ required for operating the corresponding signal light 200G1 and the signal light 200G2. However, in other embodiments of the disclosure, the controller 130 does not necessarily generate the current selection signal S2.

It should be noted that in other operation modes of the embodiment, different control signals SR, SY, SG1, SG2 may also be received to make different signal lights emit light. Moreover, in other embodiments, the controller 130 may also be configured to receive a control signal different from that of the aforementioned modes. Moreover, in the embodiment, the situation of simultaneously turning on two signal lights is taken as an example for description. However, in other embodiments of the disclosure, three or more signal lights may be simultaneously turned on, and the number of the signal lights that are turned on simultaneously is not limited by the disclosure.

In summary, the control device of the disclosure includes a power supply, a switching element and a controller. The controller receives a control signal and generates a switching signal according to the control signal, and the switching element turns on/off a circuit corresponding to a specific signal light according to the switching signal, so as to transmit the driving current to one of the signal lights. Based on such design, one power supply may provide the driving current required for operating a plurality of signal lights, and it is unnecessary to configure one power supply for each of the signal lights, so that the volume of the control device may be reduced, installation of the control device is easier, and maintenance thereof is more convenient.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. A control device, configured to receive a control signal to control a plurality of signal lights, the control device comprising:
a power supply, configured to output a driving current;
a switching element, coupled between the power supply and the signal lights, and configured to transmit the driving current to one of the signal lights according to a switching signal; and
a controller, coupled to the switching element, and configured to receive the control signal and generate the switching signal according to the control signal, wherein the controller is further coupled to the power supply, and is configured to generate a current selection signal according to the control signal, wherein the power supply outputs the driving current according to the current selection signal.

2. (canceled)

3. The control device as claimed in claim 1, wherein the power supply comprises a current selector configured to determine a magnitude of the driving current according to the current selection signal.

4. The control device as claimed in claim 1, wherein the controller receives the control signal from at least one of a plurality of channels, and generates the switching signal according to the at least one of the channels, wherein each of the channels corresponds to one of the signal lights.

5. The control device as claimed in claim 4, wherein the controller receives the control signal from a traffic light controller.

6. The control device as claimed in claim 5, wherein the signal lights, the control device and the traffic light controller are separated from each other, the control device is disposed at a periphery of the signal lights, and the traffic light controller is disposed at a periphery of the control device.

7. A traffic light system, operating according to a control signal, the traffic light system comprising:
a plurality of signal lights; and
a control device, comprising:
a power supply, configured to output a driving current;
a switching element, coupled between the power supply and the signal lights, and configured to transmit the driving current to one of the signal lights according to a switching signal; and
a controller, coupled to the switching element, and configured to receive the control signal and generate the switching signal according to the control signal, wherein the controller is further coupled to the power supply, and is configured to generate a current selection signal according to the control signal, wherein the power supply outputs the driving current according to the current selection signal.

8. (canceled)

9. The traffic light system as claimed in claim 7, wherein the power supply comprises a current selector configured to determine a magnitude of the driving current according to the current selection signal.

10. The traffic light system as claimed in claim 7, wherein the controller receives the control signal from at least one of a plurality of channels, and generates the switching signal according to the at least one of the channels, wherein each of the channels corresponds to one of the signal lights.

11. The traffic light system as claimed in claim 10, wherein the controller receives the control signal from a traffic light controller.

12. The traffic light system as claimed in claim 11, wherein the signal lights, the control device and the traffic light controller are separated from each other, the control device is disposed at a periphery of the signal lights, and the traffic light controller is disposed at a periphery of the control device.
